(19) United States
(12) Patent Application Publication
(10) Pub. No.: US 2007/0219902 A1
(43) Pub. Date: Sep. 20, 2007

(54) Electronic payment method and related system and devices

(75) Inventor: Thierry Lucidarme, Montigny (FR)

Correspondence Address: TROP PRUNER & HU, PC, 1616 S. VOSS ROAD, SUITE 750, HOUSTON, TX, 77057-2631, US

(73) Assignee: Nortel Networks Limited, St. Laurent (CA)

(21) Appl. No.: 11/385,033

(22) Filed: Mar. 20, 2006

(51) Int. Cl. G06Q 40/00

(52) U.S. Cl. 705/39

(57) ABSTRACT

The invention proposes an electronic payment method through a telecommunication network, the payment relating to a service provided to a buying entity by a selling entity. According to the method, an amount corresponding to the service is debited from an account of the buying entity. At least first and second information elements representing respective parts of a paying means corresponding to said amount are received, at the buying entity, both first and second information elements being required to get paid of said amount. The first information element is transmitted to the selling entity. The buying entity is provided with said service. And the second information element is conditionally transmitted to the selling entity.

### BACKGROUND OF THE INVENTION

The present invention relates to electronic payment.

It more particularly relates to electronic payment through a telecommunication network, the payment relating to a service provided to a buying entity by a selling entity.

In the following, the term “service” should be understood in a broad way. It can include an electronic service, such as a transfer of files through the telecommunication network, but also the delivery of a good. In the latter case, of course, only the payment is made electronically.

The invention is well adapted to the non exclusive case where the seller and the buyer have limited or even no trust relationship with each other. It can apply to different business situations such as C to C (customer to customer), B to B (business to business), C to B or B to C.

Some electronic payment methods in a telecommunication network, e.g. the Internet, are known.

In a common model, used e.g. by eBay™, any Internet user can operate as a seller and can offer a good to any other Internet user on the basis of a rough description and/or a low definition picture. In this model, some regulation occurs due to the fact that each buyer can appraise a seller and any Internet user can have access to this appraisal in order to get an idea of the level of risks he takes. But, there is no guarantee that a bought good will finally be delivered and will meet the buyer's expectations.

Moreover, in most known systems, buyers are requested to pay for a service in advance i.e. before the service is provided. This is not a problem so long as the sellers are known to be serious and reliable. But, with the multiplicity of small and unknown sellers, over the Internet for instance, the level of trust is declining.

Therefore, there is a need for an electronic payment method that could lower the risks that a buyer does not pay for a service he gets from a seller and that a seller does not provide the service expected by a buyer.

An object of the present invention is thus to answer this need.

Another object of the invention is to strongly incite both parties to find an agreement on the transaction (in terms of features, quality of service, delay, price, etc.) and to fulfill their respective commitments.

### SUMMARY OF THE INVENTION

The invention proposes an electronic payment method in a telecommunication network, the payment relating to a service provided to a buying entity by a selling entity. The method comprises the steps of:
debiting an amount corresponding to the service from an account of the buying entity;
receiving, at the buying entity, at least first and second information elements representing respective parts of a paying means corresponding to said amount, both first and second information elements being required to get paid of said amount;
transmitting the first information element to the selling entity;
providing the buying entity with said service; and
conditionally transmitting the second information element to the selling entity.

In this way, the buying entity is debited before the service is provided, which lowers the risk that the selling entity is not paid for the service provided. And the selling entity can be paid only after it has received the second information element from the buying entity, i.e. after the buying entity has been provided with said service, which lowers the risk that the selling entity does not provide the service or provides a service which is not in accordance with what was initially claimed.

This method can be seen as a provision, by the buying entity, of two or more parts of a payment means successively, like two halves of a single electronic bank note cut in two.

It thus offers some guarantee to the parties in a limited or no trust context. Indeed, the method provides a strong incitation to the two parties to find an agreement and to respect their respective commitments.

Cryptographic functions, such as signature, authentication and ciphering can advantageously be used during the transaction, in order to secure it.

When the second information element is not transmitted to the selling entity, a third party, such as a humanitarian or charity organization, can be credited instead. Alternately, a third information element can be generated and sent to the selling entity for a limited amount. The buying entity can also be refunded with part of the initial price of the service, after supplementary negotiation steps for instance.

The electronic payment of the invention can apply in a telecommunication network comprising at least an Internet part or at least one Ambient network for instance. Several Ambient networks could be involved as well, for example within the framework of a composition procedure.

The invention also proposes a buying entity for paying for a service provided by a selling entity, through a telecommunication network. The buying entity comprises:
means for receiving at least first and second information elements representing respective parts of a paying means corresponding to an amount corresponding to the service, both first and second information elements being required to get paid of said amount;
means for transmitting the first information element to the selling entity;
means for being provided with said service; and
means for conditionally transmitting the second information element to the selling entity.

The invention also proposes a selling entity for providing a service to a buying entity in exchange for a payment through a telecommunication network. The selling entity comprises:
means for receiving a first information element from the buying entity;
means for providing the buying entity with said service; and
means for receiving a second information element from the buying entity, and the first and second information elements represent respective parts of a paying means corresponding to an amount corresponding to the service, both first and second information elements being required to get paid of said amount.

The invention also proposes a bank server for allowing the electronic payment of a service provided to a buying entity by a selling entity. The bank server comprises:
means for debiting an amount corresponding to the service from an account of the buying entity;
means for generating and sending the buying entity at least first and second information elements representing respective parts of a paying means corresponding to said amount, both first and second information elements being required to get paid of said amount;
means for receiving the at least first and second information elements from the selling entity; and
means for crediting an account of the selling entity with said amount corresponding to the service responsive to a reception by said means for receiving the at least first and second information elements from the selling entity.

The invention also proposes a system capable of enabling a payment relating to a service provided to a buying entity by a selling entity and comprising:
means for debiting an amount corresponding to the service from an account of the buying entity;
means for receiving, at the buying entity, at least first and second information elements representing respective parts of a paying means corresponding to said amount, both first and second information elements being required to get paid of said amount;
means for transmitting the first information element to the selling entity;
means for providing the buying entity with said service; and
means for conditionally transmitting the second information element to the selling entity.

The invention also proposes a computer program comprising code instructions for carrying out at least some of the following steps, when loaded and run on computer means:
debiting an amount corresponding to the service from an account of the buying entity;
receiving, at the buying entity, at least first and second information elements representing respective parts of a paying means corresponding to said amount, both first and second information elements being required to get paid of said amount;
transmitting the first information element to the selling entity;
providing the buying entity with said service; and
conditionally transmitting the second information element to the selling entity.

The preferred features of the above aspects which are indicated by the dependent claims may be combined as appropriate, and may be combined with any of the above aspects of the invention, as would be apparent to a person skilled in the art.

### BRIEF DESCRIPTION OF THE DRAWINGS

FIG. 1 is a schematic representation showing possible exchanges within the framework of an electronic payment for a service according to the invention;

FIG. 2 is an example of information elements used within the framework of an electronic payment according to the invention.

### DESCRIPTION OF PREFERRED EMBODIMENTS

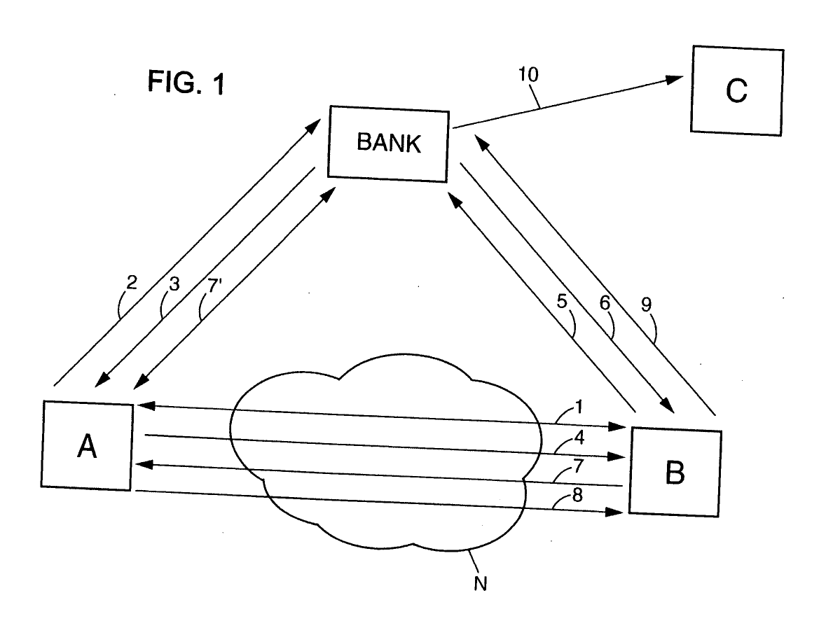

FIG. 1 shows a buying entity or buyer A and a selling entity or seller B. A wishes to buy a service offered by B. Both A and B can use electronic devices, such as computers, personal digital assistant, mobile terminals, etc. capable of communicating with each other through a telecommunication network N. In the following, it should be understood that the buyer A and the seller B can refer either to the users themselves or to their respective communication devices.

The network N can be of any type. It can comprise an Internet part for instance. It can also comprise one or several Ambient networks as will be explained later. It can comprise wire line communication means and/or wireless communication means.

According to the electronic payment method of the present invention, B first proposes a service. This service can be of any type. It can comprise electronic operations, e.g. a transfer of files (software, movies, videos, music, etc.). It can also comprise non electronic operations, such as the delivery of a good by classical ways such as air mail for instance.

A has access to B's offer, because the latter is directed to A or simply accessible to any person. For example, B's offer can be advertised on a Web site so that everybody can see it. Advantageously, B's offer includes a description of the service offered, including e.g. photographs, a description of the main features, a state, a quality of service, a price, etc. as well as other information such as a delivery lead time.

Once A is aware of B's offer (step 1), he can decide to buy the service offered. It is assumed that A and B can authenticate with each other initially so as to secure the transaction.

If A decides to buy the service offered by B, he advantageously contacts his bank (step 2). In the following, the term “bank” will designate either the bank itself or a server managed by the bank (bank server). A is thus authenticated with his bank and asks for authorization to pay the amount i.e. the price P corresponding to the service.

The bank then checks whether-the account of A contains an amount of money more than P. If this check is positive, the bank debits A's account of the amount P. At this stage, it is as if A had already paid for the service offered by B, but B, who has not yet provided A with the service, is not yet paid for it.

The bank also generates and sends A two or more information elements which represent respective parts of a paying means corresponding to the amount P (step 3). The information elements are arranged so that all of them are required to get paid of P.

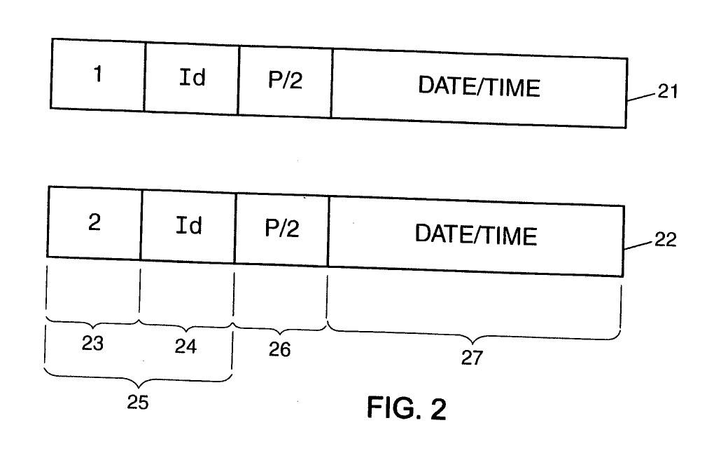

FIG. 2 shows an example of first and second such information elements 21 and 22. The information elements 21 and 22 advantageously both contain identification information and information relating to the amount P corresponding to the service offered by B.

In the example of FIG. 2, the identification information 25 comprises two fields 23 and 24. The field 23 is a number of the respective information element, i.e. “1” for the information element 21 and “2” for the information element 22. The field 24 includes a common identifier Id which can be a random number chosen by the bank for instance. This common identifier helps making both information elements 21 and 22 indissociable. Of course, other identifiers could be used instead or in addition to the one of FIG. 2.

In other words, the information elements 21 and 22 can be seen as two parts of a single paying means like a bank note and the common identifier Id identifies this paying means, whereas the field 23 identifies each part of this paying means.

Still in the example of FIG. 2, the information relating to the amount P comprises a field 26 in each one of the two information elements 21 and 22. This field 26 contains a respective part of the amount P. In the illustrated example, the fields 26 of both information elements 21 and 22 contain the amount p/2. But, in other examples, they could contain another distribution of P. For example, the field 26 of the information element 21 could contain 3P/4, while the field 26 of the information element 21 could contain P/4, or any other distribution.

The information elements 21 and 22 may further comprise date and/or time information. This information may be included in a field 27 concatenated with the above mentioned information, as shown in FIG. 2.

The information elements are advantageously signed, in a classical way, with a secret key of the bank. In this way, it can be checked, by virtue of a corresponding public key, whether the information elements really originate from the bank.

Advantageously, the information elements comprise information hashed with a hash function. For example, the information elements sent to A could comprise the information 21-22 shown in FIG. 2 hashed with such hash function. Any known hash function which maps the values in a set of a large number of values with the values of another set of a smaller number of values can be used to this end. Preferably, the hashed values contain at least 160 bits as it is common, in order to have a complexity of 2⁸⁰. The number of possible collisions by using the hash function is thus very limited.

Famous examples of hash functions that can be used within the framework of the present invention are SHA-1 (specified in the “Secure Hash Signature Standard (SHS)” by the NIST (see FIPS PUB 180-2)) or MD5 (see Request For Comments 1319-121 published by the Internet Engineering Task Force (IETF)) for instance. Of course, other hash functions would suit as well.

When hashed information is used, it is preferably stored in the bank so that the bank can retrieve the corresponding information from a generated hash code.

In another advantageous embodiment, the information elements comprise a message authentication code hashed (HMAC) with a keyed hash function. An advantage of this embodiment is that only the bank can check the validity and thus the integrity of the information elements generated with such keyed hash function.

Examples of standardized keyed hash functions that can be used within the framework of the present invention are MD5-MAC, HMAC-SHA-96 or MAC-CBC-AES. The first two ones use known hash functions H. When applied to an information message M, they can use a formula such as HMAC(M)=H(H(M//k//c1)//k//c2), in which k represents a secret key, c1 and c2 represent constant values and // represents a concatenation operator. The MAC-CBC-AES function uses an AES (Advanced Encryption Standard) type secret key algorithm. All these functions are well known by one skilled in the art.

The communication channel used to send the information elements from the bank to A is advantageously secured. This security can use the well known Diffie-Hellman (DH) process for instance.

Then, A sends only part of the information elements received from the bank to B (step 4). In the example described above, only the first information element 21 (which can advantageously be signed and/or hashed as explained above) is sent to B at this stage.

B advantageously authenticates and creates a secured channel to communicate with the bank. B also transmits the information element 21 received from A to the bank over the created secured communication channel (step 5).

When the information element 21 is signed, the bank can check the validity and integrity of it. The Id field 24 and date/time field 27 can also be checked so as to avoid some forgery attacks. When the information element 21 is hashed, the check further includes a step in which the bank retrieves the related information from the hashed codes it has stored previously.

Once the check has been achieved, the bank informs B of its result (step 6).

In case the check is successful, i.e. the first information element 21 is valid, B then provides A with the requested service (step 7). Indeed, B has a good level of certainty that he will be paid by A, because A has already been debited of the price P of this service by his bank.

Afterwards, A conditionally transmits the rest of the information elements, i.e. the second information element 22 in the present example, to B (step 8). A typical condition for transmitting or not the second information element 22 to B is whether or not A is satisfied with the service offered by B. For example, A is free not to send the second information element 22 to B if the service was not provided by B or if the service provided by B is not in accordance with what was advertised by B or with A's expectations.

By contrast, if A is satisfied with the service provided by B, he will send the second information element 22 to B. There is indeed no reason why A would not do so in this case, since A has already been debited of the amount P corresponding to the service requested.

When A sends the second information element 22 to B, the latter thus has all the information elements composing the paying means. In other words, B has both halves of an electronic bank note that will allow him to get paid for the service provided.

To this end, B transmits the second information element 22 to the bank (step 9). The bank, which had already received the first information element 21 from B, is thus capable of crediting the account of B of the amount P indicated by these information elements (P/2 for each one of the information elements 21 and 22 in the example of FIG. 2). In this way, B gets paid of the amount P for the service provided to A, according to their agreement.

When A does not send the second information element 22 to B, for example because he is not happy with the service provided by B, other actions can be made. These actions can be made after the bank has been informed, e.g. by A or B, of the fact that A has not sent the second information element 22 to B.

As an example of such actions, the bank can credit a third party C instead of B of at least part of the amount P (step 10). The third party C can advantageously be a humanitarian or charity organization. This organization can be chosen from respective organizations lists of A and B.

For instance, A and B can exchange their respective lists at the very beginning of the transaction (in an authentication certificates exchange phase for instance) and the first accepted organization in common in the lists can be selected in case of final disagreement. Of course, other selection mechanisms are also possible.

As another example, A may request from the bank a third information element in replacement of the second information element 22. The bank may thus invalidate the second information element 22 and generate third information element with a similar format to the second information element 22. The third information element preferably includes an amount P′ less than the one included in the second information element 22. That is, in the present example, 0≦P′<P/2.

A can then send the third information element to B in lieu of the second information element. B sends it to the bank which can credit B's account of a corresponding amount P/2+P′. The amount P′ may be set after a negotiation between A and B.

A may also be re-credited by the bank of the amount not credited to B, that is, in the previous example, of P/2-P′.

It should be noted that in the previous description, only one bank was considered. But, A and B could also have different banks. In this case, different bank servers could implement the operations relating to A and B respectively.

Moreover, what is called a bank in FIG. 1 could be a trusted broker capable of communicating with the respective banks of A and B.

Most of or all the operations described above can be carried out by means of one or several computer programs including appropriate code instructions and loaded and run on computer means.

As suggested before, the electronic payment method described above is well adapted to payment over the Internet. In another advantageous embodiment, the electronic payment method can apply to Ambient networks.

Ambient Networks is an integrated project within the European Union. This project has developed a new networking concept that embraces a very wide range of user scenarios, and accommodates a diverse set of current and innovative solutions. It gives rise to standardization. For example, the document IST-2002-507134-AN-WP1-D05, version 1.0, published in December 2005, describes the AN (“Ambient Networks”) framework architecture.

When the buyer A and the seller B mentioned above belong to the same Ambient network, the latter preferably implements the electronic payment method of the present invention.

It is also possible that the buyer A and the seller B belong to two different Ambient networks. In this case, a so-called composition procedure can take place, so that the two different Ambient networks create a third Ambient network. Within the framework of this procedure, many issues need to be arranged between the two initial Ambient networks involved, as explained in section 4.3.2 of the above mentioned document IST-2002-507134-AN-WP1-D05.

According to the present invention, one of these issues can comprise conditions of the electronic payment as described above.

Of course, the present invention can also take place within any other system or network as will be appreciated by one skilled in the art.

We claim:

1. An electronic payment method through a telecommunication network, the payment relating to a service provided to a buying entity by a selling entity and comprising the steps of:
debiting an amount corresponding to the service from an account of the buying entity;
receiving, at the buying entity, at least first and second information elements representing respective parts of a paying means corresponding to said amount, both first and second information elements being required to get paid of said amount;
transmitting the first information element to the selling entity;
providing the buying entity with said service; and
conditionally transmitting the second information element to the selling entity.

2. A method as claimed in claim 1, wherein the second information element is transmitted to the selling entity only when the buying entity is satisfied with the service provided.

3. A method as claimed in claim 1, wherein the at least first and second information elements are generated and transmitted to the buying entity by a bank server.

4. A method as claimed in claim 3, further comprising the steps of transmitting the at least first and second information elements from the selling entity to the bank server and, once both first and second information elements have been received at the bank server, crediting an account of the selling entity with said amount corresponding to the service.

5. A method as claimed in claim 3, wherein the at least first and second information elements are signed with a secret key of the bank server.

6. A method as claimed in claim 3, wherein the bank server on the one hand and the buying entity and the selling entity on the other hand communicate through the telecommunication network over respective secured communication channels.

7. A method as claimed in claim 3, wherein the buying entity and the selling entity authenticate with the bank server.

8. A method as claimed in claim 1, wherein the at least first and second information elements comprise identification information and information relating to said amount corresponding to the service.

9. A method as claimed in claim 8, wherein the identification information comprises, for each one of the at least first and second information elements, a respective number and a common identifier.

10. A method as claimed in claim 8, wherein the information relating to said amount corresponding to the service comprises, for each one of the at least first and second information elements, an indication of a respective part of said amount.

11. A method as claimed in claim 1, wherein the at least first and second information elements comprise time and/or date information.

12. A method as claimed in claim 1, wherein the at least first and second information elements comprise information hashed with a hash function.

13. A method as claimed in claim 1, wherein the at least first and second information elements comprise a message authentication code hashed with a keyed hash function.

14. A method as claimed in claim 1, wherein the buying entity is provided with said service only after validity and/or integrity of the first information element transmitted to the selling entity has been checked.

15. A method as claimed in claim 1, comprising the further step of crediting a third party, such as a humanitarian or charity organization, of at least part of said amount corresponding to the service, when the second information element is not transmitted to the selling entity.

16. A method as claimed in claim 1, wherein the at least first and second information elements comprise an indication of respective parts of said amount corresponding to the service, the method further comprising the following steps, when the second information element is not transmitted to the selling entity:
receiving, at the buying entity, a third information element in replacement of the second information element, said third information element comprising an indication of an amount less than said respective part of said amount corresponding to the service comprised in the second information element;
transmitting the third information element to the selling entity, in lieu of the second element.

17. A method as claimed in claim 1, wherein the telecommunication network comprises at least an Internet part.

18. A method as claimed in claim 1, wherein the telecommunication network comprises at least one Ambient network.

19. A method as claimed in claim 18, wherein the buying entity and the selling entity belong to respective Ambient networks and wherein the electronic payment is carried out within the framework of a composition procedure between said Ambient networks.

20. A buying entity for paying for a service provided by a selling entity, through a telecommunication network, the buying entity comprising:
means for receiving at least first and second information elements representing respective parts of a paying means corresponding to an amount corresponding to the service, both first and second information elements being required to get paid of said amount;
means for transmitting the first information element to the selling entity;
means for being provided with said service; and
means for conditionally transmitting the second information element to the selling entity.

21. A buying entity as claimed in claim 20, wherein the means for conditionally transmitting the second information element to the selling entity are arranged for transmitting the second information element to the selling entity only when the buying entity is satisfied with the service provided.

22. A buying entity as claimed in claim 20, wherein means for receiving at least first and second information elements are arranged for receiving at least first and second information elements from a bank server.

23. A buying entity as claimed in claim 22, wherein the at least first and second information elements are signed with a secret key of the bank server.

24. A buying entity as claimed in claim 22, comprising means for communicating with the bank server through the telecommunication network over a secured communication channel.

25. A buying entity as claimed in claim 22, comprising means for authenticating with the bank server.

26. A buying entity as claimed in claim 20, wherein the at least first and second information elements comprise information hashed with a hash function.

27. A buying entity as claimed in claim 20, wherein the at least first and second information elements comprise a message authentication code hashed with a keyed hash function.

28. A buying entity as claimed in claim 20, wherein the at least first and second information elements comprise an indication of respective parts of said amount corresponding to the service, the buying entity further comprising the following means carried out when the second information element is not transmitted to the selling entity:
means for receiving a third information element in replacement of the second information element, said third information element comprising an indication of an amount less than said respective part of said amount corresponding to the service comprised in the second information element;
means for transmitting the third information element to the selling entity, in lieu of the second element.

29. A buying entity as claimed in claim 20, comprising Internet communication means for communicating with at least an Internet part of the telecommunication network.

30. A buying entity as claimed in claim 20, comprising communication means for communicating with at least one Ambient network of the telecommunication network.

31. A selling entity for providing a service to a buying entity in exchange for a payment through a telecommunication network, the selling entity comprising:
means for receiving a first information element from the buying entity;
means for providing the buying entity with said service; and
means for receiving a second information element from the buying entity, wherein the first and second information elements represent respective parts of a paying means corresponding to an amount corresponding to the service, both first and second information elements being required to get paid of said amount.

32. A selling entity as claimed in claim 31, further comprising means for transmitting the first and second information elements to a bank server which has generated said first and second information elements.

33. A selling entity as claimed in claim 32, comprising means for communicating with the bank server through the telecommunication network over a secured communication channel.

34. A selling entity as claimed in claim 32, comprising means for authenticating with the bank server.

35. A selling entity as claimed in claim 31, comprising means for receiving a result of a validity and/or integrity check of the first information element and wherein the means for providing the buying entity with said service are carried out depending on the result received by said means for receiving a result of a validity and/or integrity check of the first information element.

36. A selling entity as claimed in claim 31, comprising Internet communication means for communicating with at least an Internet part of the telecommunication network.

37. A selling entity as claimed in claim 31, comprising communication means for communicating with at least one Ambient network of the telecommunication network.

38. A bank server for allowing the electronic payment of a service provided to a buying entity by a selling entity, the bank server comprising:
means for debiting an amount corresponding to the service from an account of the buying entity;
means for generating and sending the buying entity at least first and second information elements representing respective parts of a paying means corresponding to said amount, both first and second information elements being required to get paid of said amount;
means for receiving the at least first and second information elements from the selling entity; and
means for crediting an account of the selling entity with said amount corresponding to the service responsive to a reception by said means for receiving the at least first and second information elements from the selling entity.

39. A bank server as claimed in claim 38, wherein the means for generating the at least first and second information elements comprise means for signing the at least first and second information elements with a secret key of the bank server.

40. A bank server as claimed in claim 38, comprising means for communicating with the buying entity and the selling entity through the telecommunication network over respective secured communication channels.

41. A bank server as claimed in claim 38, comprising means for authenticating the buying entity and the selling entity.

42. A bank server as claimed in claim 38, wherein the means for generating the at least first and second information elements are arranged so that the at least first and second information elements comprise identification information and information relating to said amount corresponding to the service.

43. A bank server as claimed in claim 42, wherein the identification information comprises, for each one of the at least first and second information elements, a respective number and a common identifier.

44. A bank server as claimed in claim 42, wherein the information relating to said amount corresponding to the service comprises, for each one of the at least first and second information elements, an indication of a respective part of said amount.

45. A bank server as claimed in claim 38, wherein the means for generating the at least first and second information elements are arranged so that the at least first and second information elements comprise time and/or date information.

46. A bank server as claimed in claim 38, wherein the means for generating the at least first and second information elements comprise means for hashing the at least first and second information elements with a hash function.

47. A bank server as claimed in claim 38, wherein the means for generating the at least first and second information elements comprise means for hashing the at least first and second information elements with a keyed hash function so as to obtain a message authentication code.

48. A bank server as claimed in claim 38, further comprising means for checking the validity and/or integrity of the first information element received from the selling entity.

49. A bank server as claimed in claim 38, comprising means for crediting a third party, such as a humanitarian or charity organization, of at least part of said amount corresponding to the service on request of the buying entity or the selling entity.

50. A bank server as claimed in claim 38, wherein the at least first and second information elements comprise an indication of respective parts of said amount corresponding to the service, the bank server comprising means for generating and sending the buying entity a third information element in replacement of the second information element, said third information element comprising an indication of an amount less than said respective part of said amount corresponding to the service comprised in the second information element.

51. A system capable of enabling a payment relating to a service provided to a buying entity by a selling entity and comprising:
means for debiting an amount corresponding to the service from an account of the buying entity;
means for receiving, at the buying entity, at least first and second information elements representing respective parts of a paying means corresponding to said amount, both first and second information elements being required to get paid of said amount;
means for transmitting the first information element to the selling entity;
means for providing the buying entity with said service; and
means for conditionally transmitting the second information element to the selling entity.

52. A computer program comprising code instructions for carrying out at least some of the following steps, when loaded and run on computer means:
debiting an amount corresponding to the service from an account of the buying entity;
receiving, at the buying entity, at least first and second information elements representing respective parts of a paying means corresponding to said amount, both first and second information elements being required to get paid of said amount;
transmitting the first information element to the selling entity;
providing the buying entity with said service; and
conditionally transmitting the second information element to the selling entity.
